(19) United States
(12) Patent Application Publication
(10) Pub. No.: US 2024/0295264 A1
(43) Pub. Date: Sep. 5, 2024

(54) SHIFT-BY-WIRE TRANSMISSION SYSTEM

(71) Applicants: Hyundai Motor Company, Seoul (KR); Kia Corporation, Seoul (KR); LS Automotive Technologies Co., Ltd., Anyang-si (KR)

(72) Inventors: Bum Jun KIM, Siheung-Si (KR); Kyeong Hwan CHOI, Ulsan (KR); Sung Won CHO, Yongin-si (KR); Won LEE, Siheung-si (KR); In Hyuk IM, Seoul (KR)

(73) Assignees: Hyundai Motor Company, Seoul (KR); Kia Corporation, Seoul (KR); LS Automotive Technologies Co., Ltd., Anyang-si (KR)

(21) Appl. No.: 18/385,223

(22) Filed: Oct. 30, 2023

(30) Foreign Application Priority Data
Mar. 3, 2023 (KR) 10-2023-0028549

(51) Int. Cl. F16H 59/12; G05G 5/03; G05G 5/04; G05G 5/05

(52) U.S. Cl. CPC F16H 59/12; G05G 5/03; G05G 5/04; G05G 5/05; F16H 2059/081; G05G 2505/00

(57) ABSTRACT

A shift-by-wire transmission system includes a body provided with a sensor therein; an operation portion assembly in which a magnet is provided within a detecting range of the sensor, wherein a gear shifting operation portion is rotated about an axis of the body so that the magnet is rotated with the gear shifting operation portion, and the gear shifting operation portion is moved in an axial direction of the body so that the magnet is linearly moved together with the gear shifting operation portion; and a controller configured to detect a variation in magnetic force of the magnet detected by the sensor according to a rotational displacement and a movement displacement of the magnet and detect a gear shifting signal corresponding to a gear shifting operation of the gear shifting operation portion.

### CROSS REFERENCE TO RELATED APPLICATION

The present application claims priority to Korean Patent Application No. 10-2023-0028549 filed on Mar. 3, 2023, the entire contents of which is incorporated herein for all purposes by this reference.

### BACKGROUND OF THE PRESENT DISCLOSURE

### Field of the Present Disclosure

The present disclosure relates to a shift-by-wire transmission system in which a transmission system is provided in a column to achieve a rapid and accurate gear shifting operation and improve gear shifting convenience and a product is miniaturized by efficiently configuring a detecting structure of a gear shifting stage.

### Description of Related Art

A conventional transmission system is provided in a center portion of a console and is broadly divided into a shift-by-cable type transmission system and a shift-by-wire type transmission system.

Recently, there is a tendency to expand and apply the shift-by-wire transmission system rather than the shift-by-cable transmission system. This is because the shift-by-wire transmission system has great advantages of a greater degree of freedom in design of a mounting position and operation convenience compared to the shift-by-cable transmission system.

Despite the above advantages, there is a problem in that it is not suitable to install a transmission system at the existing position where the shift-by-wire transmission system is provided to freely move and transform a seat in an indoor environment of a future autonomous driving vehicle.

Therefore, it is necessary to mount the shift-by-wire transmission system at a position different from the existing position and a product needs to be miniaturized to be mounted in other positions. However, a structure of a current transmission system includes a limitation in miniaturizing the product.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a shift-by-wire transmission system in which a transmission system is provided in a column to improve a rapid and accurate gear shifting operation and gear shifting convenience.

The present disclosure is also intended to propose a shift-by-wire transmission system which miniaturizes a product by efficiently configuring a detecting structure of a gear shifting stage.

The technical problems to be solved by the present disclosure are not limited to the above-mentioned technical problems and other technical problems which are not mentioned may be clearly understood by those skilled in the art to which the present disclosure pertains from the following description.

According to one aspect, there is provided a shift-by-wire transmission system including a body provided with a sensor therein: an operation portion assembly in which a magnet is provided within a detecting range of the sensor, wherein a gear shifting operation portion is rotated about an axis of the body so that the magnet is rotated with the gear shifting operation portion, and the gear shifting operation portion is moved in an axial direction of the body so that the magnet is linearly moved together with the gear shifting operation portion: and a controller configured to detect a variation in magnetic force of the magnet detected by the sensor according to a rotational displacement and a movement displacement of the magnet and detect a gear shifting signal corresponding to a gear shifting operation of the gear shifting operation portion.

A gear may be shifted to a gear shifting stage, excluding a P stage, according to rotation direction of the gear shifting operation portion, and the gear may be shifted to the P stage by a movement operation of the gear shifting operation portion.

The operation portion assembly may include a gear shifting knob provided at an end portion of the body as the gear shifting operation portion and rotated about the axis of the body, a gear shifting button provided to be relatively movable at an end portion of the gear shifting knob as the gear shifting operation portion and pressed in the axial direction of the body, a groove member restrictedly coupled to the gear shifting knob and rotatably inserted into the body, and a moving unit moved relative to the groove member by passing through the groove member in the axial direction of the body, restrictedly coupled between the gear shifting button and the magnet, linearly moved to vary strength of the magnetic force of the magnet in a state in which the magnet is provided with a gap with respect to the sensor, and rotated with the groove member to vary a direction of the magnetic force of the magnet.

The moving unit may include a button guide inserted into the groove member and coupled to the gear shifting button by passing through the gear shifting knob, a guide shaft coupled to the button guide by passing through the groove member, and a magnet shaft coupled to the guide shaft and including an end portion, which faces the sensor, to which the magnet is fixed.

The shift-by-wire transmission system may further include a bush bearing in which a bearing hole is formed in a center portion of the bush bearing and the magnet shaft passes through the bearing hole and which is restrictedly coupled to the groove member, in which a length of a passing-through portion of the magnet shaft formed between the magnet shaft and the guide shaft may be formed to be greater than a length in the axial length of an internal diameter of the bearing hole to allow a linear movement of the magnet shaft.

The shift-by-wire transmission system may further include a moving restoring member provided between the button guide and the groove member and configured to provide an elastic restoration force for a pressing movement of the gear shifting button.

A guide support may be formed in the button guide, a groove support may be formed in the groove member facing the guide support, a nipple-shaped rubber portion may be formed to protrude from the moving restoring member, and one end portion and the other end portion of the rubber portion may be supported between the guide support and the groove support.

A guide pin may be formed to protrude from the groove member, and a pinhole including a shape corresponding to the guide pin may be formed in the moving restoring member so that the moving restoring member may be assembled to the groove member.

A guide support may be formed at left and right sides of the button guide, a return damper may be formed in the guide support, and a knob stopper may be formed to protrude from left and right sides of an internal surface of the gear shifting knob facing the return damper so that the knob stopper may be supported on the return damper.

The shift-by-wire transmission system may further include a rotating damper provided to protrude from an external surface of the guide shaft and rotated with the guide shaft, and a housing stopper provided on a path where the rotating damper is rotated inside the body and configured to limit a rotation angle of the rotating damper.

The housing may be coupled to inside of the body, and the housing stopper may be formed in the housing in a shape of partially surrounding the guide shaft.

The shift-by-wire transmission system may further include a groove stopper formed to protrude in a radial direction of the groove member and rotated with the groove member, and a body stopper formed on an internal surface of the body and provided on a path where the groove stopper is rotated to limit a rotation angle of a rotating damper.

A damper groove may be formed on the internal surface of the body, the groove stopper may be inserted with a gap with respect to an internal surface of the damper groove, and the body stopper may be formed in a shape for blocking left and right sides of the damper groove.

A maximum rotation angle of the groove stopper may be greater than a maximum rotation angle of the rotating damper.

The shift-by-wire transmission system may further include a shielding member provided in a shape for surrounding the sensor and the magnet inside the body and configured to shield an external magnetic field of the magnet.

The shielding member may be a magnetic material.

The shielding member may be embedded in the housing coupled to inside of the body.

The shift-by-wire transmission system may further include a rotational restoration portion configured to provide an elastic restoration force for a rotation of the groove member according to a rotational operation of the gear shifting knob.

The rotational restoration portion may include a gear shifting groove formed at an end portion of the groove member in a groove shape along the rotation path, a bullet groove formed in the housing coupled to inside of the body, a bullet movably inserted into the bullet groove and supported on the gear shifting groove, and a return spring configured to provide an elastic restoring force to the bullet in a direction toward the gear shifting groove.

The bullet groove may be formed in the axial direction of the body so that an opening of the bullet groove may be formed to face the gear shifting groove, and the return spring may be supported between an end portion of an internal side of the bullet groove and the bullet.

The shift-by-wire transmission system may further include a haptic element fixed to the housing coupled to inside of the body and configured to generate a vibration when a gear is shifted to a predetermined gear shifting stage, an end portion of the housing may be inserted into an end portion of the groove member so that the vibration generated from the haptic element may be transmitted from the housing to the groove member, and the vibration transmitted to the groove member may be transmitted to the gear shifting knob.

The shift-by-wire transmission system may further include a start button provided on an external side of the body and operated by pressing, an indicator configured to display each gear shifting stage on the external side of the body, a start lamp provided toward the start button inside the body and turned on or off according to an operation of the start button, and an indicator lamp provided toward the indicator inside the body and turned on or off according to a gear shifting operation of the gear shifting operation portion.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram illustrating an external appearance of a shift-by-wire transmission system according to an exemplary embodiment of the present disclosure:

FIG. 2 is an exploded diagram illustrating the shift-by-wire transmission system according to an exemplary embodiment of the present disclosure:

FIG. 3 is a diagram illustrating the external appearance of the shift-by-wire transmission system when viewed from the top portion according to an exemplary embodiment of the present disclosure:

FIG. 4 is a cross-sectional view taken along line A-A of FIG. 3:

FIG. 5 is a diagram illustrating an operation in which a distance to a sensor is changed by linearly moving a magnet according to an exemplary embodiment of the present disclosure:

FIG. 6 is a cross-sectional view taken along line B-B of FIG. 3:

FIG. 7 is a diagram illustrating a state in which a gear shifting knob and a groove member are coupled by a snap-fit engagement structure according to an exemplary embodiment of the present disclosure;

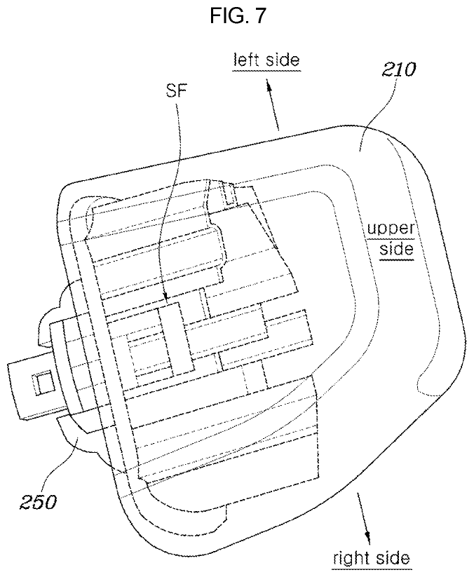

FIG. 8 is a diagram for describing a shape of a moving unit and a coupling relationship between the moving unit and a bush bearing according to an exemplary embodiment of the present disclosure;

FIG. 9 is a diagram illustrating a gap reduction rib formed in a button guide according to an exemplary embodiment of the present disclosure:

FIG. 10 is an enlarged view exemplarily illustrating a state in which a guide shaft and a magnet shaft are separated according to an exemplary embodiment of the present disclosure:

FIG. 11 is a diagram illustrating a gap reduction rib formed on the guide shaft according to an exemplary embodiment of the present disclosure:

FIG. 12 is a diagram illustrating the external appearance of a shift-by-wire transmission system when viewed from the side according to an exemplary embodiment of the present disclosure:

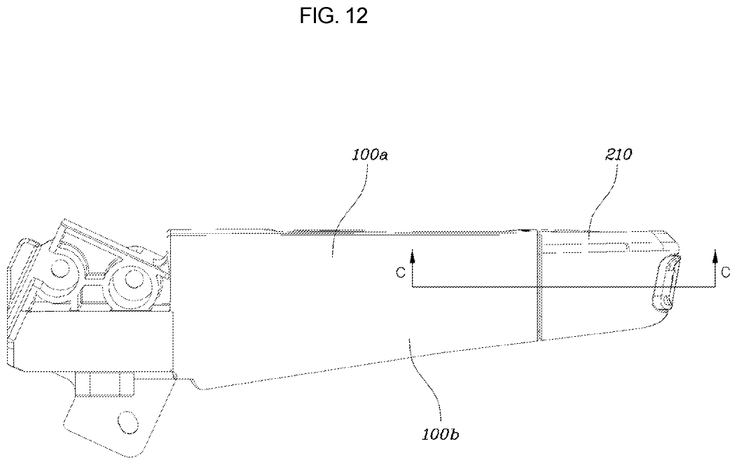

FIG. 13 is a cross-sectional view taken along line C-C of FIG. 12:

FIG. 14 is a diagram illustrating a coupling relationship between a groove member and a moving restoring member according to an exemplary embodiment of the present disclosure:

FIG. 15 is a diagram illustrating a housing stopper and a rotating damper according to an exemplary embodiment of the present disclosure:

FIG. 16 is a diagram for describing an operation in which a rotating damper is supported on the housing stopper according to an exemplary embodiment of the present disclosure:

FIG. 17 is a diagram for describing an operation in which a groove stopper is supported on a body stopper according to an exemplary embodiment of the present disclosure:

FIG. 18 is a diagram for describing a structure in which a bullet is supported on a gear shifting groove by a return spring according to an exemplary embodiment of the present disclosure:

FIG. 19 is a diagram illustrating a shape of the gear shifting groove according to an exemplary embodiment of the present disclosure;

FIG. 20 is a diagram for describing an operation of shifting a gear to an N stage Nd and a D stage according to a rotational operation in one direction and a rotation angle of the magnet according to an exemplary embodiment of the present disclosure; and

FIG. 21 is a diagram for describing an operation of shifting a gear to an N stage Nr and an R stage according to a rotation in another direction and a rotation angle of the magnet according to an exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, embodiments included in the present specification will be described in detail with reference to the drawings. The same reference numerals are provided to the same or similar components regardless of reference numerals, and a repetitive description thereof will be omitted.

As used herein, suffixes “module” and “portion” for a component of the present disclosure are used or interchangeably used solely for ease of preparation of the specification, and do not have different meanings and each thereof does not function by itself.

In the following description of the present specification, when a detailed description of a known related art is determined to obscure the gist of the present specification, the detailed description thereof will be omitted herein. Furthermore, the accompanying drawings are merely for easy understanding of the exemplary embodiments included in the present specification, the technical spirit included in the present specification is not limited by the accompanying drawings, and it should be understood to include all modifications, equivalents, and substitutes included in the spirit and scope of the present disclosure.

Terms including ordinal numbers such as first, second, and the like used herein may be used to describe various components, but the various components are not limited by these terms. The terms are used only for distinguishing one component from another component.

When a component is referred to as being “connected” or “coupled” to another component, the component may be directly connected or coupled to another component, but it should be understood that sill another component may be present between the component and another component. On the other hand, when a component is referred to as being “directly connected,” or “directly coupled” to another component, it should be understood that yet another component may not be present between the component and another component.

Unless the context clearly dictates otherwise, the singular form includes the plural form.

In the present specification, the terms “comprising,” “having,” or the like are used to specify that a feature, a number, a step, an operation, a component, an element, or a combination thereof described herein exists, and they do not preclude the presence or addition of one or more other features, numbers, steps, operations, components, elements, or combinations thereof.

A controller may include a communication device configured for communicating with other control units or sensors to control a responsible function, a memory for storing an operating system, a logic command, and input/output information, and one or more processors for performing determination, calculation, and decision which are necessary for controlling the responsible function.

Exemplary embodiments of the present disclosure will be described below in detail with reference to the accompanying drawings.

A shift-by-wire transmission system of the present disclosure includes a body 100 provided with a sensor 410 therein, an operation portion assembly 200 in which a magnet 280 is provided within a detecting range of the sensor 410, a gear shifting operation portion is rotated about an axis of the body 100 so that the magnet 280 is rotated with the gear shifting operation portion, and the gear shifting operation portion is moved in an axial direction of the body 100 so that the magnet 280 is linearly moved together with the gear shifting operation portion, and a controller 400 configured to detect a variation in magnetic force of the magnet 280 detected by the sensor 410 according to a rotational displacement and movement displacement of the magnet 280 and detect a gear shifting signal corresponding to a gear shifting operation of the gear shifting operation portion.

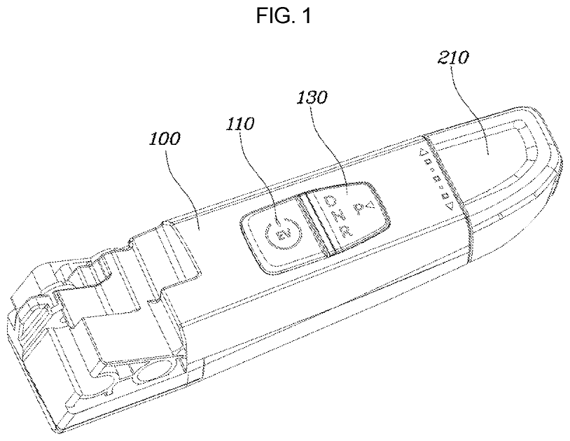

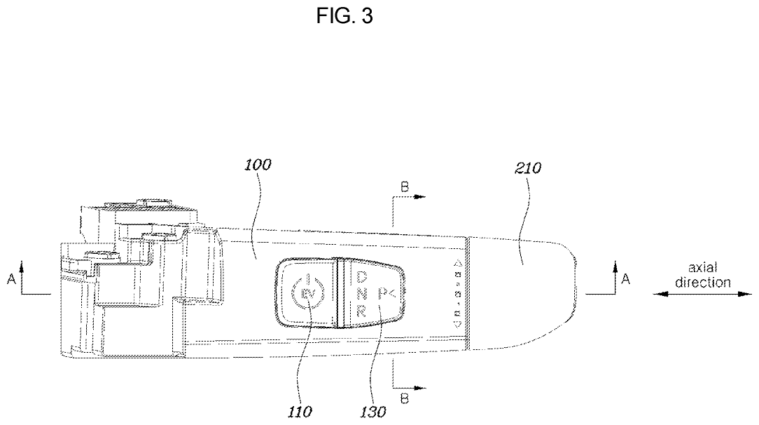

To describe in detail with reference to FIGS. 1 to 6, the body 100 may be provided at a position where a gear shifting operation is possible without interference of a seat in an autonomous vehicle in which the seat is freely moved and deformed. As an exemplary example, the shift-by-wire transmission system may be provided on a side surface of a steering column.

The body 100 is configured by assembling an upper body 100a and a lower body 100b and is formed in a container shape elongated in a longitudinal direction to fix and support internal portions.

The controller 400 may be embedded inside the body 100, and the sensor 410 configured to detect the magnet 280 may be connected to the controller 400.

For reference, the controller 400 may be implemented on a printed circuit board (PCB).

Furthermore, according to the specifications of the sensor 410 (a dual die and a single die), the sensor 410 may be provided as a single sensor 410 or a plurality of sensors 410 at a position corresponding to the magnet 280. In an exemplary embodiment of the present disclosure, a plurality of single die magnetic sensors are disposed at the rotation center portion of the magnet 280 so that a magnetic force measurement error may be reduced and the magnet 280 may be miniaturized.

This sensor 410 detects R/N/D stage gear shifting operations and a P stage gear shifting operation through the gear shifting operation portion, and when a signal detected by the sensor 410 is input, the controller 400 may be configured for controlling to form a gear shifting stage corresponding to the detected gear shifting operation.

Because the operation portion assembly 200 is provided in an axial direction of the body 100 and the magnet 280 is provided in the operation portion assembly 200, the magnet 280 is rotated with a rotation of the operation portion assembly 200 so that a magnetic force of the magnet 280 detected by the sensor 410 varies.

Furthermore, the magnet 280 is moved together with a movement of the operation portion assembly 200 so that the magnetic force of the magnet 280 detected by the sensor 410 varies.

As an exemplary embodiment of the present disclosure, the gear shifting operation portion includes a gear shifting knob 210 and a gear shifting button 220, and when the gear shifting knob 210 is rotated, the gear shifting operation portion shifts a gear to a gear shifting stage, excluding the P stage, according to a rotational operation and a rotation direction of the gear shifting knob 210.

The gear shifting stage, excluding the P stage, may be an R stage, an N stage, or a D stage. When the gear shifting knob 210 is rotated in one direction, the gear is shifted to the D stage, and when the gear shifting knob 210 is rotated in another direction, the gear is shifted to the R stage, and before the gear is shifted to the D stage or the R stage by the rotation of the gear shifting knob 210 in one direction or another direction, the gear is shifted to the N stage at an Nd or Nr position.

Furthermore, when the gear shifting button 220 is pressed, the gear shifting button 220 is linearly moved toward the inside of the body 100 with respect to the gear shifting knob 210 to shift the gear to the P stage. In the instant case, the gear shifting knob 210 is positioned at a neutral position.

As described above, according to an exemplary embodiment of the present disclosure, the transmission system is provided in the column, and the variation of the magnetic force of the magnet 280 according to the rotational operation and pressing operation of the gear shifting operation portion is detected through the sensor 410 to shift the gear shifting stage so that the gear shifting operation may be performed rapidly and accurately and convenience of the gear shifting operation may be improved.

Meanwhile, the operation portion assembly 200 according to an exemplary embodiment of the present disclosure includes a gear shifting knob 210, a gear shifting button 220, a groove member 250, and a moving unit.

That is, the operation portion assembly 200 includes the gear shifting knob 210 provided at an end portion of the body 100 as the gear shifting operation portion and rotated about the axis of the body 100, the gear shifting button 220 provided to be relatively movable at an end portion of the gear shifting knob 210 as the gear shifting operation portion and pressed in the axial direction of the body 100, the groove member 250 restrictedly coupled to the gear shifting knob 210 and rotatably inserted into the body 100, and the moving unit which is moved relative to the groove member 250 by passing through the groove member 250 in the axial direction of the body 100 and is restrictedly coupled between the gear shifting button 220 and the magnet 280, in which the magnet 280 is linearly moved to vary the magnetic force strength thereof in a state in which the magnet 280 is provided with a gap g from the sensor 410, and which is rotated with the groove member 250 to vary a direction of the magnetic force of the magnet 280.

For reference, hereinafter, it is noted that, in expressing directions of components including the operation portion assembly 200, a direction opposite to a steering column based on the body 100 is defined and expressed as “one end,” and a direction toward the steering column is defined and expressed as “the other end.”

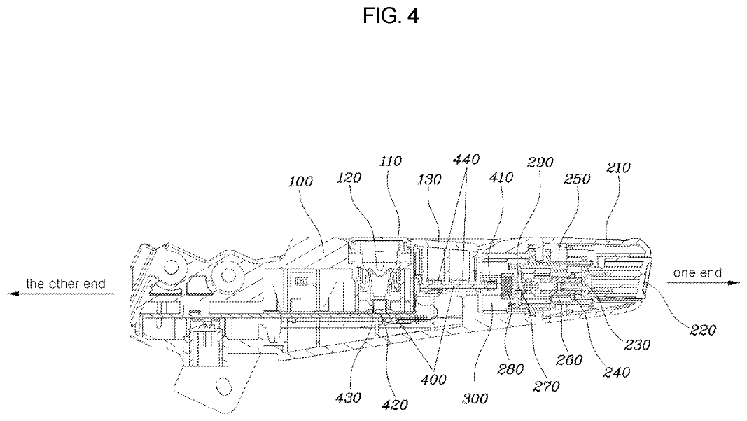

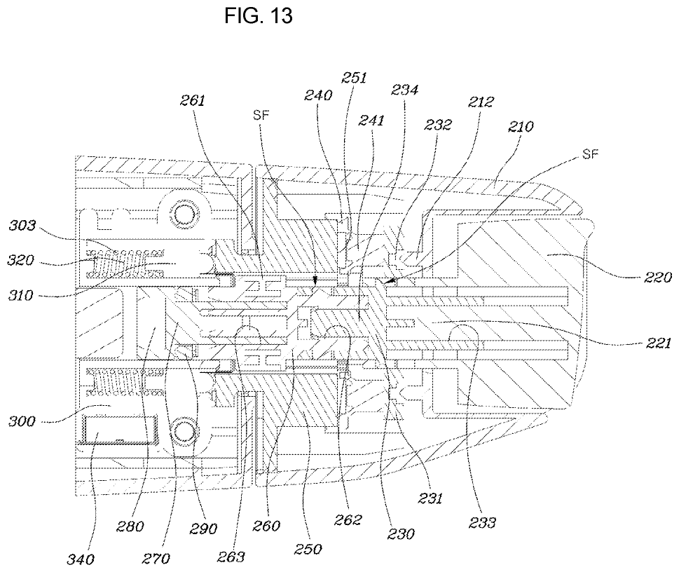

To describe with reference to FIGS. 4 and 13, the other end portion of the body 100 is coupled to the steering column, and the gear shifting knob 210 is provided at one end portion of the body 100 opposite to the steering column.

Furthermore, the groove member 250 is inserted into and coupled to inside of the gear shifting knob 210.

For example, hooks are formed on upper and lower external surfaces of the groove member 250, hook grooves including shapes corresponding to the hooks are formed on upper and lower internal surfaces of the gear shifting knob 210, and the groove member 250 is engaged with the gear shifting knob 210 by a snap-fit engagement structure SF between the hook and the hook groove.

Furthermore, a plurality of position fixing ribs 211 are formed to protrude from the internal surface of the gear shifting knob 210 in the axial direction of the body 100, position fixing grooves 256 including shapes corresponding to the position fixing ribs 211 are formed on the external surface of the groove member 250, and the position fixing ribs 211 are inserted into the position fixing grooves 256. Thus, the groove member 250 and the gear shifting knob 210 are assembled without a gap.

Furthermore, an axis is formed in the longitudinal direction of the body 100, and one end portion of the groove member 250 is rotatably provided at one end portion of the body 100 around the axis so that, when the gear shifting knob 210 is rotated, the groove member 250 is rotated with the gear shifting knob 210.

One end portion of the gear shifting button 220 is provided at the center portion of the gear shifting knob 210 in a form of being externally exposed of the gear shifting knob 210.

Furthermore, one end portion of the moving unit is coupled to the gear shifting button 220, and the moving unit passes through the groove member 250 to be embedded in the axial direction of the body 100.

In the instant case, the moving unit is moved relative to the groove member 250 and is pressed toward the inside of the body 100 in the axial direction together with the gear shifting button 220. However, the moving unit is restricted and rotated with the groove member 250, and when the groove member 250 is rotated, the moving unit and the magnet 280 are also rotated.

The magnet 280 is fixed to the other end portion of the moving unit, and the magnet 280 is provided with a predetermined gap g from the sensor 410.

Here, the gap g is a distance between a Hall element for detecting a magnetic force inside the sensor 410 and a surface of the magnet 280.

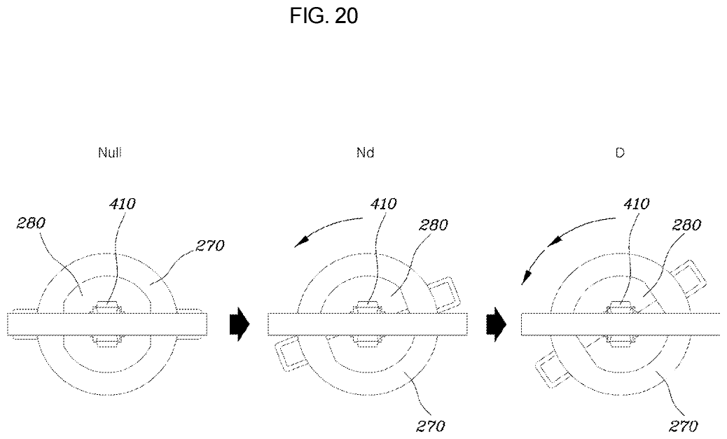

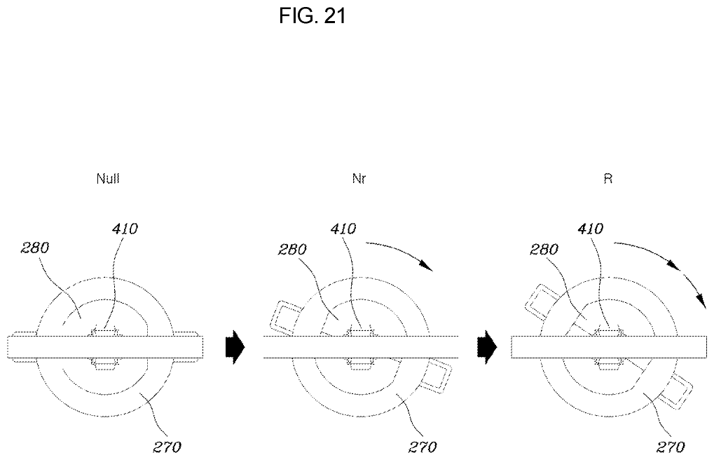

That is, as shown in FIGS. 20 and 21, when the gear shifting knob 210 is rotated, the magnet 280 is rotated, and a direction of a magnetic force changes according to the rotation of the magnet 280. Thus, when a changing magnetic force value is detected and the detected magnetic force value is detected as a predetermined magnetic force value, a gear shifting stage signal (R stage, N stage, or D stage) corresponding to the corresponding magnetic force value is recognized, and thus a gear shifting operation may be performed.

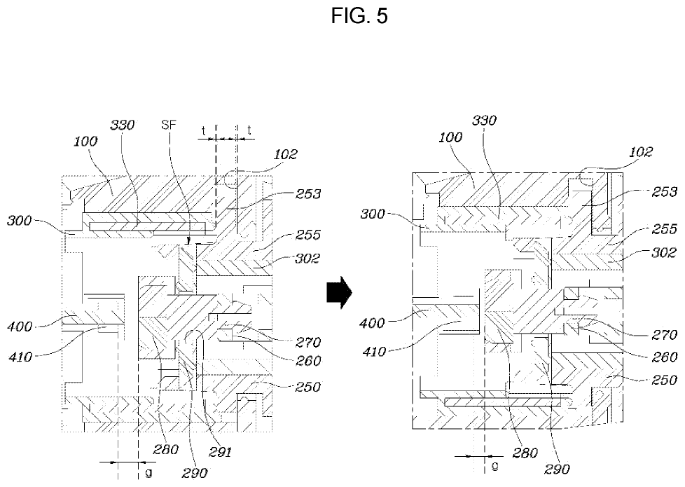

Furthermore, as shown in FIG. 5, when the gear shifting button 220 is pressed, the magnet 280 is moved toward the sensor 410, and a strength of the magnetic force changes according to the movement of the magnet 280. Thus, when a changing magnetic force value is detected and the detected magnetic force value is detected as a predetermined magnetic force value, a gear shifting stage signal (P stage) corresponding to the corresponding magnetic force value is recognized, and thus a gear shifting operation may be performed.

Furthermore, the moving unit includes a button guide 230, a guide shaft 260, the magnet 280, and a magnet shaft 270.

That is, the moving unit includes the button guide 230 inserted into the groove member 250 and coupled to the gear shifting button 220 by passing through the gear shifting knob 210, the guide shaft 260 coupled to the button guide 230 by passing through the groove member 250, and the magnet shaft 270 which is coupled to the guide shaft 260 and of which an end portion facing the sensor 410 is fixed to the magnet 280.

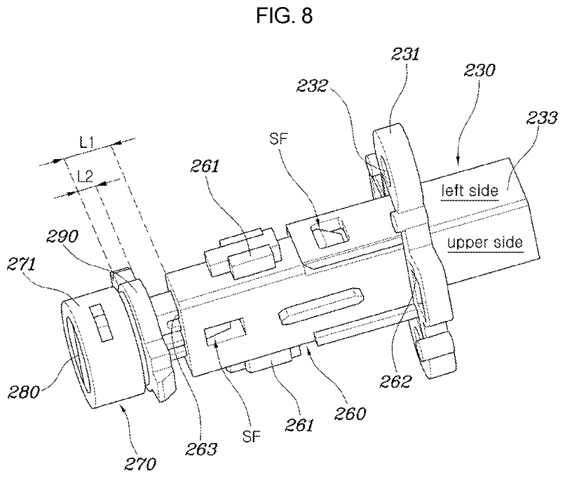

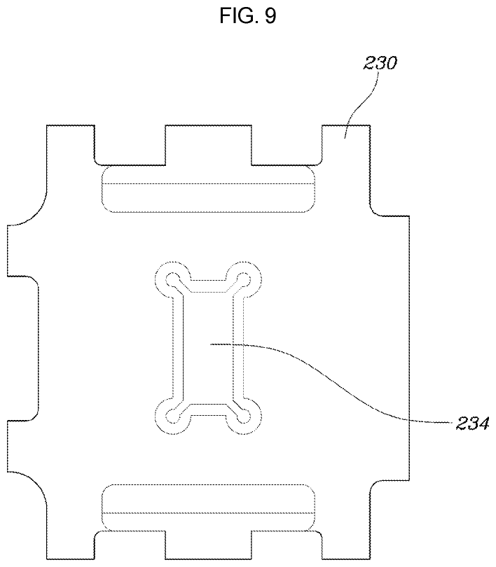

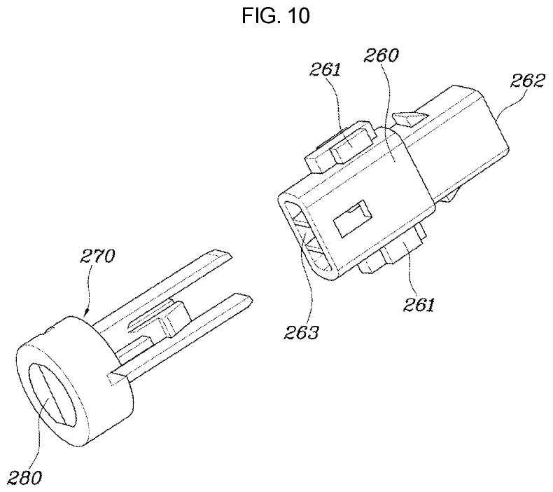

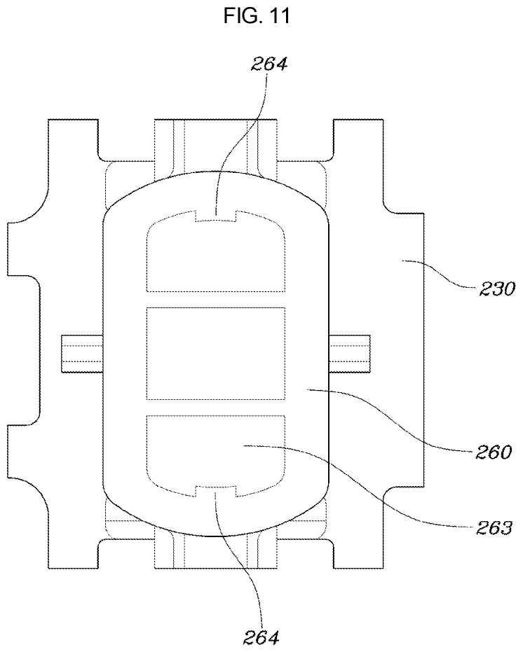

To describe in detail with reference to FIG. 8, FIG. 9, FIG. 10 and FIGS. 11 and 13, a quadrangular groove 233 is formed at the center portion of one end portion of the button guide 230.

Furthermore, a protrusion 221 including a shape corresponding to the groove 233 is formed at the center portion of the other end portion of the gear shifting button 220 and is inserted and assembled into the groove 233 of the button guide 230.

Furthermore, hooks are formed on left and right external surfaces in the middle portion of the button guide 230, hook grooves including shapes corresponding to the hooks are formed on left and right of the other end portion of the gear shifting button 220, and thus the gear shifting button 220 and the button guide 230 are engaged by a snap-fit engagement structure SF between the hook and the hook groove.

Furthermore, hooks are formed on left and right external surfaces of the guide shaft 260, hook grooves including shapes corresponding to the hooks are formed on left and right external surfaces of the other end portion of the button guide 230, and thus the guide shaft 260 and the button guide 230 are engaged by a snap-fit engagement structure SF between the hook and the hook groove.

In the instant case, a gap reduction rib 234 is formed in the middle portion of the button guide 230 facing the guide shaft 260, a quadrangular-shaped button side groove 262 corresponding to the gap reduction rib 234 of the button guide 230 is formed at one end portion of the guide shaft 260, the gap reduction rib 234 is inserted into the button side groove 262, and thus an assembly gap between the guide shaft 260 and the button guide 230 is reduced.

Furthermore, hooks are formed on upper and lower external surfaces of the magnet shaft 270, hook grooves including shapes corresponding to the hooks are formed on upper and lower external surfaces of the other end portion of the guide shaft 260, and thus the magnet shaft 270 and the guide shaft 260 are engaged by a snap-fit engagement structure SF between the hook and the hook groove.

In the instant case, a magnet side groove 263 is formed at the other end portion of the guide shaft 260, a gap reduction rib 264 is formed on an internal surface of the magnet side groove 263, one end portion of the magnet shaft 270 is inserted into the magnet side groove 263 to be supported on the gap reduction rib 264, and thus an assembly gap between the magnet shaft 270 and the guide shaft 260 is reduced.

The magnet 280 may be fixed to the center portion of the other end portion of the magnet shaft 270 through insert injection, and the external surface of the magnet 280 may be provided in a state of being exposed toward the sensor 410.

That is, the gear shifting button 220 and the button guide 230, the button guide 230 and the guide shaft 260, and the guide shaft 260 and the magnet shaft 270 are respectively engaged by the snap-fit engagement structure SF. Thus, a rib structure is formed in a portion where a gap may occur between the components so that the moving unit is securely mounted.

Furthermore, the present disclosure includes a bush bearing 290 in which a bearing hole 291 is formed at the center portion and the magnet shaft 270 passes through the bearing hole 291 and which is restrictedly coupled to the groove member 250.

In the instant case, a length L1 of a passing-through portion of the magnet shaft 270 formed between the magnet shaft 270 and the guide shaft 260 is formed to be greater than a length L2 of an internal diameter of the bearing hole 291 in the axial direction so that the magnet shaft 270 is allowed to be linearly moved.

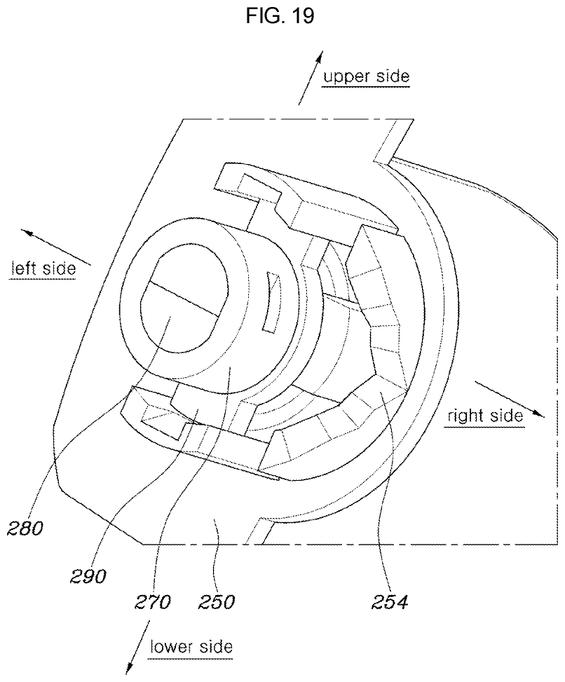

Referring to FIGS. 8 and 19, the bush bearing 290 is formed in an annular shape, hooks are formed on upper and lower external surfaces of the bush bearing 290, hook grooves including shapes corresponding to the hooks are formed on upper and lower external surfaces of the other end portion of the groove member 250, and thus the groove member 250 and the bush bearing 290 are engaged by a snap-fit engagement structure SF between the hook and the hook groove.

Thus, because the magnet shaft 270 is guided by the bush bearing 290 to be moved linearly, the linear movement of the moving unit is stably performed.

Furthermore, a catch portion 271 is formed at the other end portion of the magnet shaft 270 to which the magnet 280 is fixed, a cross-sectional area of the catch portion 271 is formed to be greater than a cross-sectional area of the bearing hole 291, and a cross-sectional area of an edge portion of the magnet side groove formed at the other end portion of the guide shaft 260 is also formed to be greater than the cross-sectional area of the bearing hole 291.

In the instant case, a portion between the catch portion 271 and the magnet side groove 263 of the guide shaft 260 becomes the passing-through portion, and the length of the passing-through portion is formed to be greater than the length of the bush bearing 290 in the axial direction thereof.

Thus, the magnet shaft 270 is linearly moved within the length range of the passing-through portion, limiting an excessive movement of the moving unit.

Meanwhile, as shown in FIG. 13, the present disclosure may further include a moving restoring member 240 provided between the button guide 230 and the groove member 250 and configured to provide an elastic restoration force for a pressing movement of the gear shifting button 220.

That is, when the gear shifting button 220 is pressed toward the body 100, the button guide 230 is restored and moved in a direction opposite to the body 100 due to an elastic restoration force of the moving restoring member 240. Thus, a position of the moving unit including the button guide 230 together with the gear shifting button 220 is restored to a position before the gear shifting operation of the gear shifting button 220.

To describe the configuration for restoring the position of the gear shifting button 220 in more detail, a guide support 231 is formed in the button guide 230, a groove support 251 is formed in the groove member 250 facing the guide support 231, and a nipple-shaped rubber portion 241 is formed to protrude from the moving restoring member 240 so that one end portion and the other end portion of the rubber portion 241 may be supported and pressed between the guide support 231 and the groove support 251.

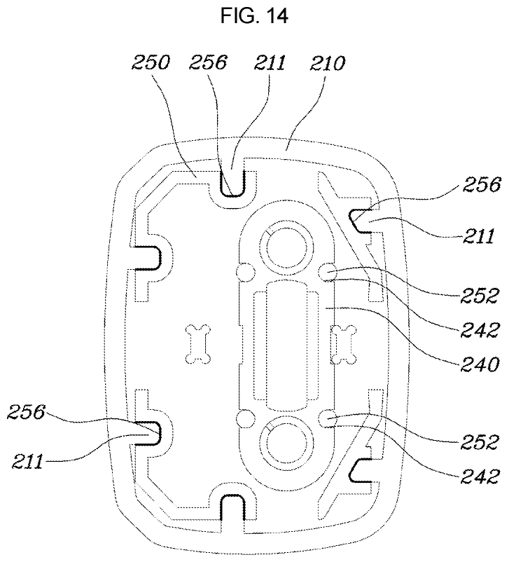

For example, as shown in FIGS. 13 and 14, a surface facing the body 100 among both surfaces of the moving restoring member 240 is supported on the groove support 251 and assembled to the groove member 250.

The moving restoring member 240 is formed in an elliptical shape, a plurality of pinholes 242 are formed along an edge portion of the moving restoring member 240, and guide pins 252 including shapes corresponding to the pinholes 242 are formed to protrude from the groove member 250. Thus, the guide pins 252 are inserted into the pinholes 242, and thus the moving restoring member 240 is assembled to the groove member 250.

Furthermore, a rubber portion 241 is formed to protrude from a surface facing the gear shifting button 220 among both the surfaces of the moving restoring member 240 in a form of a nipple.

Furthermore, a guide support 231 is formed in the middle portion of the button guide 230 in an outwardly extending shape, and the rubber portion 241 is supported on the guide support 231. The rubber portion 241 may be formed of an elastic material.

That is, when the gear shifting button 220 is pressed, the rubber portion 241 of the moving restoring member 240 is compressed and thus an elastic restoration force is generated. Thus, when the pressing operation of the gear shifting button 220 is released, a force is applied to push the guide support 231 in a direction of the gear shifting button 220 due to the elastic restoration force of the rubber portion 241, and thus the gear shifting button 220 together with a gear shifting guide is restored and moved to a position before the pressing operation.

Furthermore, guide supports 231 are formed at left and right sides of the button guide 230, a return damper 232 is formed on the guide support 231, and knob stoppers 212 are formed to protrude from left and right internal surfaces of the gear shifting knob 210 facing the return damper 232 to be supported on the return damper 232.

That is, the return damper 232 made of an elastic material is embedded in the guide support 231, and thus one surface of the return damper 232 is exposed toward the knob stopper 212.

Furthermore, the knob stopper 212 is formed to include a cross-sectional area which is smaller than a cross-sectional area of the return damper 232 and is supported on the return damper 232.

Therefore, when the gear shifting button 220 is restored and moved after the pressing operation of the gear shifting button 220, the return damper 232 is supported on the knob stopper 212, and thus a noise generated in the restoration operation of the gear shifting button 220 is reduced.

Furthermore, because the return damper 232 and the knob stopper 212 are formed to be compact and to include a simplified structure, the noise may be reduced without increasing a size of the product.

Meanwhile, the present disclosure includes rotating dampers 261 provided to protrude from an external surface of the guide shaft 260 and rotated with the guide shaft 260, and housing stopper 301 provided on paths in which the rotating dampers 261 are vertically rotated inside the body 100 and configured to limit rotation angles of the rotating dampers 261.

Furthermore, the housing 300 may be coupled to the body 100, and the housing stopper 301 may be formed in the housing 300 to partially surround the guide shaft 260.

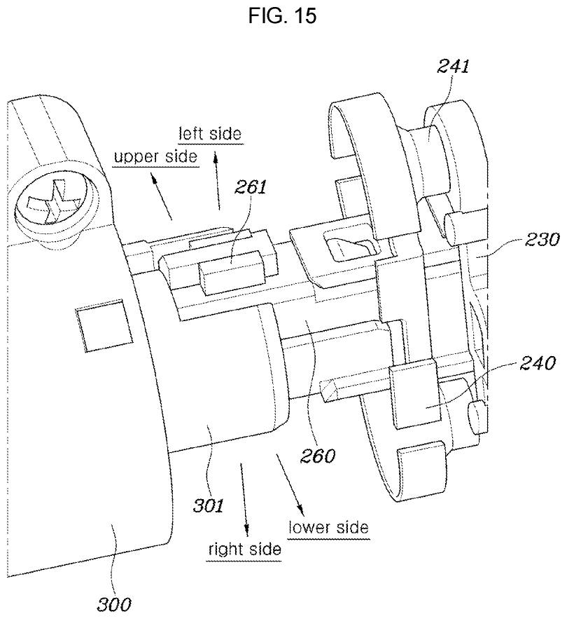

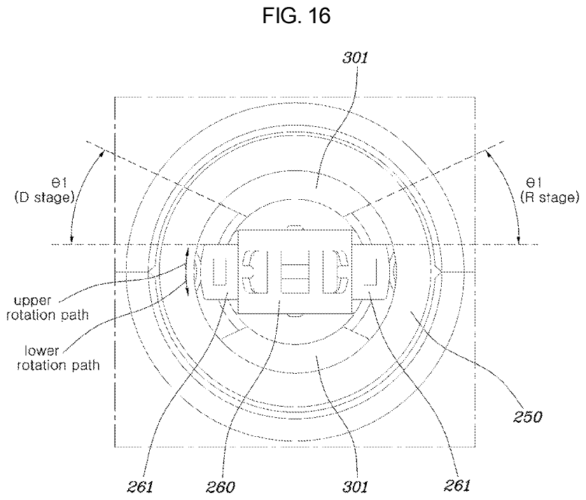

To describe in detail with reference to FIG. 15 and FIG. 16, the rotating dampers 261 each made of an elastic material are provided at left and right sides of the external surface of the guide shaft 260. Here, the rotating dampers 261 may be fixed to the guide shaft 260 through a double injection method.

Furthermore, the housing 300 is coupled to an internal surface of the body 100, and the housing stopper 301 is formed at a distal portion of the other end portion of the housing 300.

The housing stoppers 301 are each formed in an arc shape on upper and lower rotation paths of the rotating dampers 261. The housing stopper 301, which is formed on a rotation path in one direction of the rotating damper 261, is formed at a predetermined angle with respect to the rotating damper 261 to serve as a stopper for a gear shifting manipulation direction to the D stage, and the housing stopper 301, which is formed on a rotation path in another direction of the rotating damper 261, is formed at a predetermined angle with respect to the rotating damper 261 to serve as a stopper for a gear shifting manipulation direction to the R stage.

Thus, when the gear shifting knob 210 is rotated in one direction for the gear shifting to the D stage, the rotating damper 261 is rotated in one direction by as much as a predetermined angle together with the guide shaft 260 and is supported on the housing stopper 301, and thus an operating noise generated by the rotation operation of the gear shifting knob 210 is suppressed.

Furthermore, when the gear shifting knob 210 is rotated in another direction for the gear shifting to the R stage, the rotating damper 261 is rotated in another direction by as much as a predetermined angle together with the guide shaft 260 and is supported on the housing stopper 301, and thus an operating noise generated by the rotation operation of the gear shifting knob 210 is suppressed.

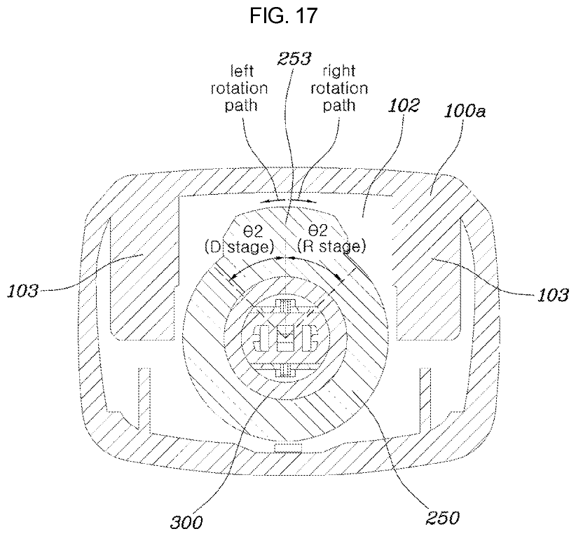

Furthermore, as shown in FIGS. 5 and 17, the present disclosure includes a groove stopper 253 formed to protrude in a radial direction of the groove member 250 and rotated with the groove member 250, and body stoppers 103 formed on the internal surface of the body 100 and provided on paths where the groove stopper 253 rotates to the left and right to limit the rotation angles of the rotating dampers 261.

That is, the groove stopper 253 is formed to protrude from an external circumferential surface of the middle portion of the groove member 250.

Furthermore, the body stoppers 103 are respectively formed on the paths where the groove stopper 253 rotates to the left and right.

In the instant case, the body stopper 103 formed on a rotation path in one direction of the groove stopper 253 is formed at a predetermined angle with respect to the groove stopper 253 to serve as a stopper for a gear shifting manipulation direction to the D stage, and the body stopper 103 formed on a rotation path in another direction of the groove stopper 253 is formed at a predetermined angle with respect to the groove stopper 253 to serve as a stopper for a gear shifting manipulation direction to the R stage.

Thus, when the gear shifting knob 210 is rotated in one direction for the gear shifting to the D stage, the groove stopper 253 is rotated in one direction by as much as a predetermined angle together with the groove member 250 and is supported on the body stopper 103.

Furthermore, when the gear shifting knob 210 is rotated in another direction for the gear shifting to the R stage, the groove stopper 253 is rotated in another direction by as much as a predetermined angle together with the groove member 250 and is supported on the body stopper 103.

Here, a maximum rotation angle θ2 of the groove stopper 253 may be formed to be greater than a maximum rotation angle θ1 of the rotating damper 261.

Thus, when the gear shifting knob 210 is rotated, the rotating damper 261 made of an elastic material collides with the housing stopper 301 first than the groove stopper 253 to limit the rotation angle of the gear shifting knob 210.

However, when the gear shifting knob 210 is rotated with a larger rotation force in a state in which the rotating damper 261 collides with the housing stopper 301, the groove stopper 253 collides with the body stopper 103 and is supported thereon.

To describe in more detail, the rotating dampers 261 are disposed at the left and right sides of the external surface of the guide shaft 260 and come into contact with and are supported on the housing stoppers 301 formed on the upper and lower rotation paths when the gear shifting knob 210 is rotated, and the groove stopper 253 protrudes upwards from an external circumferential surface of the groove member 250 and comes in contact with and is supported on the body stoppers 103 formed on left and right rotation paths when the gear shifting knob 210 is rotated.

Here, the rotating damper 261 made of an elastic material comes into contact with first and is supported on the housing stopper 301, and when the gear shifting knob 210 is rotated with a larger rotation force in a state in which the rotating damper 261 comes in contact with the housing stopper 301, the groove stopper 253 additionally comes into contact with and is supported on the body stopper 103.

That is, because the rotating damper 261 and the groove stopper 253 are disposed to be orthogonal to each other, when the gear shifting knob 210 is rotated, the rotating damper 261 and the groove stopper 253 come into contact with and are supported on the housing stopper 301 and the body stopper 103, respectively, in the vertical and horizontal directions, and a double structure is configured so that the rotating damper 261 and the groove stopper 253 sequentially come into contact with and are supported on the stoppers 301,103. Thus, the double structure may be a structure of reducing a noise according to the operation and robustly supporting the gear shifting knob even when the gear shifting knob is manipulated by an excessive force.

Furthermore, as shown in FIG. 5, a damper groove 102 is formed on the internal surface of the body 100, a groove stopper 253 is inserted with a small gap t with respect to the internal surface of the damper groove 102, and the body stoppers 103 may each be formed in a shape for blocking left and right sides of the damper groove 102.

That is, the damper groove 102 is formed on the internal surface of the body 100 positioned in an external radial direction of the groove stopper 253, and thus the groove stopper 253 is inserted.

Furthermore, left and right wall surfaces of the damper groove 102 become the body stoppers 103 to limit a rotation angle of the groove stopper 253.

Furthermore, one side and the other side of the groove stopper 253 are inserted with the small gap t with respect to the internal surface of the damper groove 102 so that the groove stopper 253 may be rotated without being caught by the body 100.

When an external force is applied to pull the gear shifting knob 210 toward one end portion of the body 100 or to push the gear shifting knob 210 toward the other end portion of the body 100, the gap t between one surface or the other surface of the groove stopper 253 and the damper groove 102 is decreased, and thus the groove stopper 253 is supported on one of internal surfaces of both sides of the damper groove 102.

Therefore, even when a large external force or an impact is applied to the gear shifting knob 210 due to a mistake of a driver or during getting on or off a vehicle, the gear shifting knob 210 is robustly supported so that the gear shifting knob 210 is prevented from being damaged or separated.

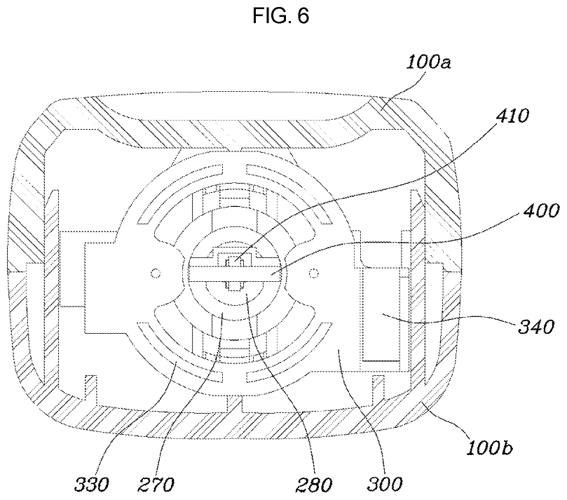

Meanwhile, as shown in FIG. 5 and FIG. 6, the present disclosure further includes a shielding member 330 provided in an annular shape that axially surrounds the sensor 410 and the magnet 280 in the body 100 and configured to shield an external magnetic field of the magnet.

That is, to reduce a magnetic force detection error of the sensor 410 due to a magnetic force input from the outside thereof, it is appropriate to form a detecting area of the sensor 410 at a position far from the outside thereof. However, the transmission system provided in the steering column includes a limitation in keeping a far distance between the detecting area and external parts due to a characteristic of a miniaturized product.

Therefore, in an exemplary embodiment of the present disclosure, by configuring the magnet 280 to face the sensor 410 to minimize the detecting area of the sensor 410, a structure for shielding the external magnetic force is implemented even by mounting the shielding member 330 to surround the sensor 410 and the magnet 280.

Therefore, the magnetic force shielding structure is miniaturized and configured to be optimized for the transmission system for the steering column.

Here, the shielding member 330 is a magnetic body formed in an annular shape and may be manufactured by bending or lathe turning after pressing.

However, the shielding member 330 is not limited to a specific material and a specific shape, and the shape of the shielding member 330 may be determined according to shapes of the surrounding parts and may be freely formed in a structure for surrounding the magnet 280 and the sensor 410.

Furthermore, the shielding member 330 may be embedded in the housing 300 coupled to the inside of the body 100.

For example, the other end portion of the housing 300 is formed in a shape of cylinder and coupled to the internal surface of the body 100 by a screw.

Furthermore, the shielding member 330 is insert-injected into the other end portion of the housing 300 in an annular shape to serve to shield a magnetic field.

That is, when the gear shifting operation portion is operated in the axial direction thereof and the magnet 280 is moved linearly, the shielding member 330 does not interfere with the linear movement path of the magnet 280 and the annular shielding member 330 shields an external magnetic field so that a rotational displacement and a movement displacement of the magnet 280 are accurately detected.

Meanwhile, in an exemplary embodiment of the present disclosure, a rotational restoration portion configured to provide an elastic restoration force to the rotation of the groove member 250 according to a rotational manipulation of the gear shifting knob 210 may be provided.

To describe a configuration of the rotational restoration portion, the rotational restoration portion includes a gear shifting groove 254 formed at an end portion of the groove member 250 in a groove shape along the rotation path, a bullet groove 303 formed in the housing 300 coupled to the inside of the body 100, a bullet 310 movably inserted into the bullet groove 303 and supported on the gear shifting groove 254, and a return spring 320 configured to provide an elastic restoration force to the bullet 310 in a direction toward the gear shifting groove 254.

Furthermore, the bullet groove 303 is formed in the axial direction of the body 100 and thus an opening of the bullet groove 303 is formed to face the gear shifting groove 254, and the return spring 320 may be supported between an internal end portion of the bullet groove 303 and the bullet 310.

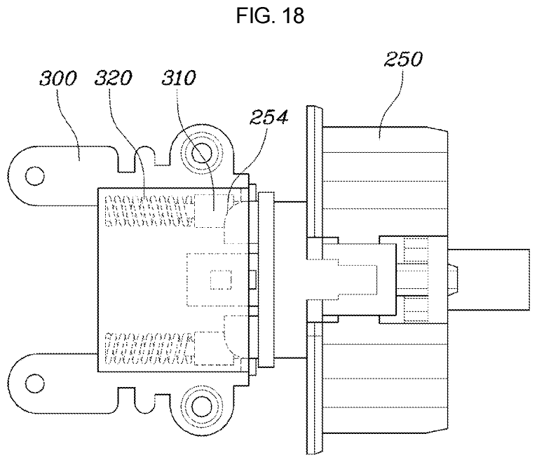

As shown in FIGS. 13 and 18, the bullet groove 303 is formed inside each of both sides of the housing 300, and the bullet 310 is inserted into the bullet groove 303. Furthermore, the return spring 320 is formed in a coil spring shape, one end portion of the return spring 320 is supported on one end portion of the bullet 310, and the other end portion of the return spring 320 is supported on an internal end portion of the bullet groove 303.

Furthermore, the gear shifting groove 254 including an inclined groove profile in a “V” shape is formed in the groove member 250 facing the bullet groove 303, and the other end portion of the bullet 310 is supported on the gear shifting groove 254.

That is, when the gear shifting knob 210 is rotated in one direction or another direction, the groove member 250 is rotated, and thus the bullet 310 supported on the gear shifting groove 254 is guided along the inclined groove profile of the gear shifting groove 254. Thus, the bullet 310 compresses the return spring 320 and is linearly moved along the bullet groove 303.

Furthermore, when the driver releases a rotational operation force of the gear shifting knob 210 in a state in which the return spring 320 is compressed by a gear shifting operation of the gear shifting knob 210 to the D or R stage, the bullet 310 is to be restored and moved again toward a central valley portion of the gear shifting groove 254 due to the elastic restoration force of the return spring 320 along the inclined surface of the gear shifting groove 254. Thus, the groove member 250 is restored and rotated to the state before the rotation, and thus the bullet 310 is positioned at the central valley portion of the gear shifting groove 254.

Thus, when the gear shifting operation is completed, the gear shifting knob 210 is restored to an initial position and moved to a null position.

For reference, as shown in FIG. 19, the gear shifting groove 254 is formed to be inclined from the center portion toward both end portions, and at least one step difference may be formed on the inclined surface.

Thus, as shown in FIGS. 20 and 21, when the gear shifting knob 210 is rotated and when the gear shifting knob 210 reaches a position of a first rotation angle, the bullet 310 is caught on the step difference of the gear shifting groove 254 and moved to an Nd or Nr position according to the rotational manipulation direction thereof. At the present position, when the bullet 310 proceeds over the step difference due to an additional rotational manipulation of the gear shifting knob 210 and thus the gear shifting knob 210 reaches a position of a second rotation angle which is greater than the first rotation angle, the gear is shifted to the D or R stage.

Therefore, a gear shifting operation feeling and a restraint feeling according to the rotational manipulation of the gear shifting knob 210 may be formed.

For reference, before the gear shifting is performed to the D stage or R stage due to the rotation in one direction or another direction of the gear shifting knob 210, the gear shifting is performed to the N stage at the Nd or Nr position.

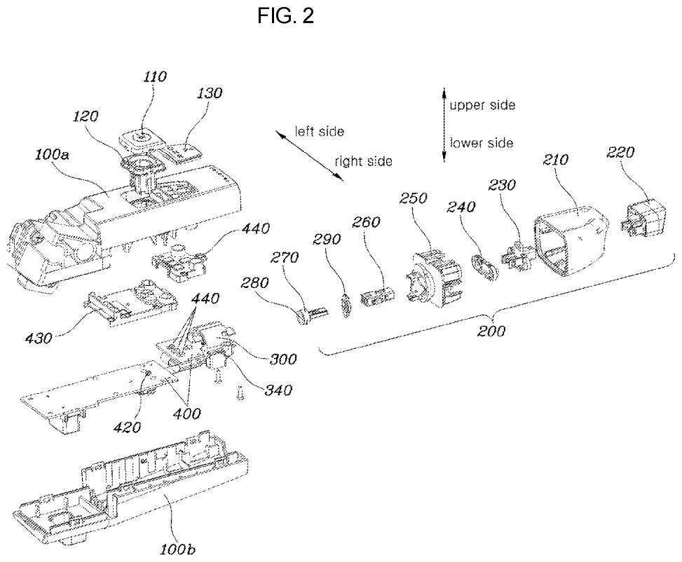

Meanwhile, as shown in FIGS. 2 and 6, the present disclosure further includes a haptic element 340 fixed to the housing 300 coupled to the inside of the body 100 and configured to generate a vibration when a gear is shifted to a specific gear shifting stage.

Furthermore, an end portion of the housing 300 is inserted into the end portion of the groove member 250, and the vibration generated from the haptic element 340 is transmitted from the housing 300 to the groove member 250 so that the vibration transmitted to the groove member 250 may be transmitted to the gear shifting knob 210.

For example, the haptic element 340 is connected to the controller 400 to receive power and a signal and is operated to generate a vibration when entering the R stage.

Because the haptic element 340 is fixed to the housing 300, the vibration generated from the haptic element 340 is transmitted to the housing 300.

Furthermore, a cylindrical housing insertion portion 302 is formed at one end portion of the housing 300 toward the groove member 250 and a cylindrical groove insertion portion 255 is formed at the other end portion of the groove member 250 toward the housing 300, and thus an external circumferential surface of the housing insertion portion 302 is inserted into an internal circumferential surface of the groove insertion portion 255.

In the instant case, because a gap between the external circumferential surface of the housing insertion portion 302 and the internal circumferential surface of the groove insertion portion 255 is formed close to zero, the vibration transmitted to the housing 300 is transmitted to the groove member 250.

Furthermore, because the groove member 250 is restrictedly coupled to the gear shifting knob 210 through the snap-fit engagement structure SF, the vibration transmitted to the groove member 250 is transmitted to the gear shifting knob 210.

Thus, when the driver manipulates the gear shifting knob 210 to shift the gear to the R stage, the vibration generated by the haptic element 340 is transmitted to the driver through the gear shifting knob 210 so that the driver may more clearly recognize that the gear shifting operation is performed to the R stage.

Meanwhile, as shown in FIGS. 1 and 4, the present disclosure includes a start button 110 provided on an external side of the body 100 and operated by pressing, an indicator 130 configured to display each gear shifting stage on the external side of the body 100, a start lamp 420 provided toward the start button 110 inside the body 100 and turned on or off according to an operation of the start button 110, and an indicator lamp 440 provided toward the indicator 130 inside the body 100 and turned on or off according to a gear shifting operation of the gear shifting operation portion.

For example, the start button 110 is provided in the upper body 100a, and a slider 120 with a hollow is coupled to the start button 110. The slider 120 is provided to be inserted into the upper body 100a and to be linearly movable toward the lower body 100b according to a pressing operation of the start button 110.

Furthermore, a printed circuit board (PCB) is provided in the body 100 as the controller 400, and a start lamp 420 is mounted on the PCB. The start lamp 420 is provided at a position directly below the slider 120.

Thus, when starting by pressing the start button 110, the start lamp 420 in a turned-on state may be turned off.

Furthermore, a start button rubber 430 made of an elastic material is assembled between the start lamp 420 and the slider 120.

Thus, the start button rubber 430 returns the start button 110 to the position before the operation of the start button 110 and is configured to emit light-emitting diode (LED) light of the start lamp 420 to the start button 110 through the hollow of the slider 120.

Furthermore, the start button rubber 430 is also configured to prevent moisture and foreign materials from entering the PCB and the start lamp 420.

Furthermore, the upper body 100a is provided with an indicator 130, and the indicator 130 displays phrases of P stage, R stage, N stage, and D stage to convey engagement information of the gear shifting stage and to guide a gear shifting operation method and an operation direction thereof.

Furthermore, indicator lamps 440 are mounted on the PCB, and the indicator lamps 440 individually display the phrases of P stage, R stage, N stage, and D stage, and each indicator lamp 440 is provided at a position directly below the displayed phrase.

Thus, when the gear shifting stage is shifted according to the gear shifting operation, the indicator lamp 440 corresponding to a phrase display of a corresponding gear shifting stage may be turned on.

Furthermore, an indicator rubber 450 made of an elastic material is assembled between the indicator lamp 440 and the indicator 130.

Thus, the indicator rubber 450 is configured to emit the light-emitting diode (LED) light of the indicator lamp 440 for each gear shifting stage phrase and to prevent moisture and foreign materials from entering the PCB and the indicator lamp 440.

Hereinafter, the gear shifting operation using the shift-by-wire transmission system of the present disclosure will be described.

To describe a gear shifting operation of a P stage with reference to FIG. 5, when the gear shifting button 220 is pressed toward the body 100, the moving unit including the gear shifting button 220 is moved toward the sensor 410, and the magnet 280 coupled to the moving unit is also moved toward the sensor 410.

Thus, the gap g formed between the magnet 280 and the sensor 410 is decreased, and thus a strength of the magnetic force of the magnet 280 detected by the sensor 410 varies.

Therefore, when the varied magnetic force value of the magnet 280 is detected as a magnetic force value corresponding to a P stage signal, a P stage gear shifting signal is generated and transmitted to the vehicle to shift a gear to the P stage.

In the present way, when the gear is shifted to the P stage by pressing the gear shifting button 220, the nipple-shaped rubber portion 241 formed on the moving restoring member 240 becomes a compressed state.

In the present state, when the driver releases the force pressing the gear shifting button 220, the button guide 230 is pushed by an elastic restoration force for restoring the compressed rubber portion 241, and the gear shifting button 220 is restored and moved to a previous position together with the moving unit.

Therefore, the driver shifts the gear while feeling the gear shifting operation of the P stage, and the gear shifting button 220 is automatically returned so that a subsequent gear shifting operation of the gear shifting button 220 may be easily performed.

Next, to describe the gear shifting operation of the R stage and the D stage with reference to FIGS. 20 and 21, when the gear shifting knob 210 is rotated in one direction at an initial position, the operation portion assembly 200 is rotated in a rotation direction of a rotation knob together with the gear shifting knob 210, and the magnet 280 included in the operation portion assembly 200 is also rotated in the rotation direction of the gear shifting knob 210.

Thus, the magnet 280 is rotated, and thus the direction of the magnetic force of the magnet 280 detected by the sensor 410 is changed.

Therefore, when the varied magnetic force value of the magnet 280 is detected as a magnetic force value corresponding to a D stage signal, a D stage gear shifting signal is generated and transmitted to the vehicle to shift the gear to the D stage.

Likewise, when the gear shifting knob 210 is rotated in another direction at the initial position, the operation portion assembly 200 is rotated in a rotation direction of a rotation knob together with the gear shifting knob 210, and the magnet 280 included in the operation portion assembly 200 is also rotated in the rotation direction of the gear shifting knob 210.

Thus, the magnet 280 is rotated, and thus the direction of the magnetic force of the magnet 280 detected by the sensor 410 is changed.

Therefore, when the varied magnetic force value of the magnet 280 is detected as a magnetic force value corresponding to an R stage signal, an R stage gear shifting signal is generated and transmitted to the vehicle to shift the gear to the R stage.

For reference, before the gear shifting is performed to the D stage or R stage due to the rotation in one direction or another direction of the gear shifting knob 210, the gear shifting is performed to the N stage at the Nd or Nr position.

In the present way, when the gear shifting knob 210 is rotated in one direction or another direction, the bullet 310 is guided along the gear shifting groove 254 and moved along the bullet groove 303 to compress the return spring 320.

In the present state, when the driver releases the force for rotating the gear shifting knob 210, the bullet 310 is restored and moved toward the valley portion along the gear shifting groove 254 due to the elastic restoration force of the return spring 320, and the gear shifting knob 210 is restored to the initial position and moved to the null position.

Therefore, the driver shifts the gear while feeling the gear shifting operation of the D or R stage, and the gear shifting knob 210 is automatically returned so that a subsequent gear shifting operation of the gear shifting knob 210 may be easily performed.

As described above, according to an exemplary embodiment of the present disclosure, the transmission system is provided in the column, the variation of the magnetic force of the magnet 280 according to the rotational operation and pressing operation of the gear shifting operation portion is detected through the sensor 410 to shift the gear shifting stage so that the gear shifting operation may be performed rapidly and accurately and convenience of the gear shifting operation may be improved.

Furthermore, there is an advantage in that the damper structure for limiting the rotation angle of the gear shifting knob 210 and the damper structure for suppressing the operating noise of the gear shifting button 220 are miniaturized and rigidly configured to allow the damper structures to be optimized in the column-type transmission system, and by simply configuring an external magnetic shielding structure, a product may be miniaturized and a production cost may be reduced.

In accordance with the present disclosure, a transmission system is provided in a column, a variation of a magnetic force of a magnet according to a rotational operation and pressing operation of a gear shifting operation portion is detected through a sensor to shift a gear shifting stage so that there is an effect capable of performing the gear shifting operation rapidly and accurately and improving the convenience of the gear shifting operation.

Furthermore, there is an advantage in that the damper structure for limiting the rotation angle of the gear shifting knob and the damper structure for suppressing the operating noise of the gear shifting button are miniaturized and rigidly configured to allow the damper structures to be optimized in the column-type transmission system, and by simply configuring an external magnetic shielding structure, there is an effect configured for miniaturizing a product and reducing a production cost.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A shift-by-wire transmission system, comprising:
a body provided with a sensor therein:
an operation portion assembly in which a magnet is provided within a detecting range of the sensor, wherein a gear shifting operation portion is rotated about an axis of the body so that the magnet is rotated with the gear shifting operation portion, and the gear shifting operation portion is moved in an axial direction of the body so that the magnet is linearly moved together with the gear shifting operation portion: and
a controller configured to detect a variation in magnetic force of the magnet detected by the sensor according to a rotational displacement and a movement displacement of the magnet and to detect a gear shifting signal corresponding to a gear shifting operation of the gear shifting operation portion.

2. The shift-by-wire transmission system of claim 1, wherein the operation portion assembly includes:
a gear shifting knob provided at an end portion of the body as the gear shifting operation portion and rotated about the axis of the body:
a gear shifting button provided to be relatively movable at an end portion of the gear shifting knob as the gear shifting operation portion and pressed in the axial direction of the body:
a groove member restrictedly coupled to the gear shifting knob and rotatably inserted into the body: and
a moving unit moved relative to the groove member by passing through the groove member in the axial direction of the body, restrictedly coupled between the gear shifting button and the magnet, linearly moved to vary strength of the magnetic force of the magnet in a state in which the magnet is provided with a gap with respect to the sensor, and rotated with the groove member to vary a direction of the magnetic force of the magnet.

3. The shift-by-wire transmission system of claim 2, wherein the moving unit includes:
a button guide inserted into the groove member and coupled to the gear shifting button by passing through the gear shifting knob;
a guide shaft coupled to the button guide by passing through the groove member: and
a magnet shaft coupled to the guide shaft and including an end portion, which faces the sensor, to which the magnet is fixed.

4. The shift-by-wire transmission system of claim 3, further including:
a bush bearing in which a bearing hole is formed in a center portion of the bush bearing and the magnet shaft passes through the bearing hole and which is restrictedly coupled to the groove member,
wherein a length of a passing-through portion of the magnet shaft formed between the magnet shaft and the guide shaft is formed to be greater than a length in the axial length of an internal diameter of the bearing hole to allow a linear movement of the magnet shaft.

5. The shift-by-wire transmission system of claim 3, further including:
a moving restoring member provided between the button guide and the groove member and configured to provide an elastic restoration force for a pressing movement of the gear shifting button.

6. The shift-by-wire transmission system of claim 5,
wherein a guide support is formed in the button guide,
wherein a groove support is formed in the groove member facing the guide support, and
wherein a nipple-shaped rubber portion is formed to protrude from the moving restoring member, and a first end portion and a second end portion of the rubber portion are supported between the guide support and the groove support.

7. The shift-by-wire transmission system of claim 5,
wherein a guide pin is formed to protrude from the groove member, and
wherein a pinhole including a shape corresponding to the guide pin is formed in the moving restoring member so that the moving restoring member is assembled to the groove member.

8. The shift-by-wire transmission system of claim 3,
wherein a guide support is formed on a side surface of the button guide,
wherein a return damper is formed in the guide support, and
wherein a knob stopper is formed to protrude from an internal surface of the gear shifting knob facing the return damper so that the knob stopper is supported on the return damper.

9. The shift-by-wire transmission system of claim 3, further including:
a rotating damper provided to protrude in a radial direction of the guide shaft and rotated with the guide shaft; and
a housing stopper provided on a path where the rotating damper is rotated inside the body and configured to limit a rotation angle of the rotating damper.

10. The shift-by-wire transmission system of claim 9, wherein a housing is coupled to inside of the body, and the housing stopper is formed in the housing in a shape of partially surrounding the guide shaft.

11. The shift-by-wire transmission system of claim 3, further including:
a groove stopper formed to protrude in a radial direction of the groove member and rotated with the groove member: and
a body stopper formed on an internal surface of the body and provided on a path where the groove stopper is rotated to limit a rotation angle of a rotating damper.

12. The shift-by-wire transmission system of claim 11,
wherein a damper groove is formed on the internal surface of the body, and the groove stopper is inserted with a gap with respect to an internal surface of the damper groove, and
wherein the body stopper is formed in a shape for blocking left and right sides of the damper groove.

13. The shift-by-wire transmission system of claim 9, wherein a maximum rotation angle of a groove stopper is greater than a maximum rotation angle of the rotating damper.

14. The moving apparatus of claim 9, wherein the rotating damper and a groove stopper are disposed to be orthogonal to each other so that, when the gear shifting knob is rotated, a double stopper structure is configured so that the rotating damper is supported on the housing stopper in a vertical direction and then the groove stopper is supported on the body stopper in a left and right direction thereof.

15. The shift-by-wire transmission system of claim 1, further including:
a shielding member provided in an annular shape for surrounding the sensor and the magnet in an axial direction inside the body and configured to shield an external magnetic field of the magnet.

16. The shift-by-wire transmission system of claim 15, wherein the shielding member is embedded in a housing coupled to inside of the body.

17. The shift-by-wire transmission system of claim 11, wherein a maximum rotation angle of the groove stopper is greater than a maximum rotation angle of a rotating damper.

18. The moving apparatus of claim 11, wherein a rotating damper and the groove stopper are disposed to be orthogonal to each other so that, when the gear shifting knob is rotated, a double stopper structure is configured so that the rotating damper is supported on the housing stopper in a vertical direction and then the groove stopper is supported on the body stopper in a left and right direction thereof.

19. The shift-by-wire transmission system of claim 2, further including:
a haptic element fixed to a housing coupled to inside of the body and configured to generate a vibration when a gear is shifted to a predetermined gear shifting stage,
wherein an end portion of the housing is inserted into an end portion of the groove member so that the vibration generated from the haptic element is transmitted from the housing to the groove member, and the vibration transmitted to the groove member is transmitted to the gear shifting knob.
